(19) United States
(12) Patent Application Publication
(10) Pub. No.: US 2017/0206351 A1
(43) Pub. Date: Jul. 20, 2017

(54) MOBILE DEVICE SECURITY MONITORING AND NOTIFICATION

(71) Applicant: VIASAT, INC., CARLSBAD, CA (US)

(72) Inventors: GREGORY R JAY, SAN DIEGO, CA (US); GERALD T PITPIT, SAN DIEGO, CA (US); F DAVID VAN VOORHEES, FOUNTAIN HILLS, AZ (US)

(73) Assignee: VIASAT, INC., CARLSBAD, CA (US)

(21) Appl. No.: 15/326,622

(22) PCT Filed: Jul. 21, 2015
(86) PCT No.: PCT/US15/41413

§ 371 Date: Jan. 16, 2017

Related U.S. Application Data
(60) Provisional application No. 62/027,547, filed on Jul. 22, 2014.

(51) Int. Cl. G06F 21/55; G06F 9/445; H04W 12/08; G06F 9/44

(52) U.S. Cl. CPC G06F 21/554; G06F 9/4406; G06F 21/552; G06F 8/62; H04W 12/08; G06F 2221/034

(57) ABSTRACT

A mobile computing device security client that monitors and detects inconsistencies in device security is described. The security client may provide a notification and/or perform an actuation in response to detection of a change in operating conditions of a mobile computing device that is inconsistent with security policies for the mobile computing device. A user notification may provide the user with an opportunity to select an action to take in response to the potential security breach. Actuations include response actions to mitigate the compromise in security based on the operating conditions. The security policies may include security policies associated with hardware peripheral use, an application whitelist, an application blacklist, and/or firewall security settings. The security client may maintain associations between operating condition inconsistencies and notifications and/or actuations to be performed.

### CROSS REFERENCE

The present application for patent claims priority to U.S. Provisional Patent Application No. 62/027,547 by Jay et al., entitled “MOBILE DEVICE SECURITY MONITORING AND NOTIFICATION:” filed Jul. 22, 2014, which is assigned to the assignee hereof.

### BACKGROUND

Mobile communication devices, such as mobile phones, have become ubiquitous in many societies. Users may carry mobile communication devices for business and personal use. The mobile communication devices are widely deployed to provide various types of communication content such as voice, video, packet data, messaging, broadcast, and so on.

Mobile communication devices may be an attractive attack surface for hacking and malware. Some threats to mobile communication devices include gathering information about the user through installed applications, turning on peripherals to gather information, intercepting communications, and the like. Mobile communication devices may be particularly vulnerable to attacks because they are almost always connected to a network, such as the Internet.

### SUMMARY

The described features generally relate to one or more improved systems, methods, and/or apparatuses for providing detection of a security inconsistency, such as an adverse hardware change, at a mobile computing device. The mobile computing device may include a security client that monitors one or more operating conditions of the mobile computing device. When a state of one of the operating conditions changes, the security client may compare the current state of the operating condition with a secured state of the operating condition. Security policies may define the secured states, which are authorized states of the operating condition. Variations of the operating conditions from the secured states may be a policy violation or may indicate, for example, that an attack vector has compromised built-in security features (e.g., kernel-level security, etc.). If the current state conflicts with the secured state, the security client may provide a notification of the discrepancy (e.g., a notification of an adverse hardware change). The security client may also take one or more actuations in response to the security inconsistency. Actuations taken by the security client may include presenting a user with optional actions to take in response to the detection of the unauthorized or insecure operating condition. The security client may also automatically take a corrective action to mitigate the discrepancy between the current state and the secured state of the operating condition.

A method for security in a mobile computing device is described. The method may include monitoring one or more operating conditions of the mobile computing device according to one or more security policies, detecting a security inconsistency between a current state of the one or more operating conditions and a secured state of the one or more operating conditions, wherein the secured state is defined by the one or more security policies, and issuing, by an output device of the mobile computing device, a notification based at least in part on the detection of the security inconsistency.

An apparatus for security in a mobile computing device is described. The apparatus may include a processor, memory in electronic communication with the processor, and instructions stored in the memory, the instructions being executable by the processor to monitor one or more operating conditions of the mobile computing device according to one or more security policies, detect a security inconsistency between a current state of the one or more operating conditions and a secured state of the one or more operating conditions, wherein the secured state is defined by the one or more security policies, and issue, by an output device of the mobile computing device, a notification based at least in part on the detection of the security inconsistency.

A non-transitory computer-readable medium storing code for notification in a mobile computing device is described. The code may include instructions executable by a processor for monitoring one or more operating conditions of the mobile computing device according to one or more security policies, detecting a security inconsistency between a current state of the one or more operating conditions and a secured state of the one or more operating conditions, wherein the secured state is defined by the one or more security policies, and issuing, by an output device of the mobile computing device, a notification based at least in part on the detection of the security inconsistency.

Some examples of the described methods may include performing, automatically upon detection of the security inconsistency, an action at the mobile computing device to mitigate the security inconsistency. The described apparatuses and/or non-transitory computer-readable medium may include instructions executable by a processor for performing these features. In some examples of the method, apparatuses, and/or non-transitory computer-readable medium, the action includes one or more of uninstalling an application, setting the one or more operating conditions to the secured state, blocking a data transfer, erasing data stored by the mobile computing device, locking the mobile computing device, rebooting the mobile computing device, blocking access to data of at least one data container, blocking at least one inter-process communication (IPC) connection, blocking at least one hardware signal, blocking at least one memory data transfer, blocking data transfer from at least one peripheral, blocking at least one software interrupt, blocking at least one system call, blocking at least one trap, erasing data of at least one data container, locking at least one data container, or combinations thereof.

In some examples of the method, apparatuses, and/or non-transitory computer-readable medium described above, the one or more security policies include associations between a set of security inconsistencies and a respective set of actions. The one or more security policies may be maintained in an application sandbox associated with a security client application of the mobile computing device.

Some examples of the described method may include monitoring the one or more operating conditions at a plurality of software levels of the mobile computing device. The described apparatuses and/or non-transitory computer-readable medium may include instructions executable by a processor for performing these features.

Some examples of the described methods may include configuring the mobile computing device according to a mobile device configuration comprising the one or more security policies, wherein the one or more operating conditions are set to match the secured state. Some examples of the described methods may include determining that the security inconsistency is an unauthorized security inconsistency. In some examples of the described methods, determining that the security inconsistency is an unauthorized security inconsistency includes comparing a current use of the mobile computing device to a pattern of past use of the mobile computing device and determining that the current use of the mobile computing device does not match the pattern of past use of the mobile computing device.

The pattern of use may be determined based on user input to one or more applications of the mobile computing device. The described apparatuses and/or non-transitory computer-readable medium may include instructions executable by a processor for performing these features.

Some examples of the described methods may include providing a second notification of the security inconsistency to a central security administrator of the mobile computing device. Some examples of the described methods may include providing, by the output device of the mobile computing device, a user-selectable option to set the current state of the one or more operating conditions to the secured state. The described apparatuses and/or non-transitory computer-readable medium may include instructions executable by a processor for performing these features.

In some examples of the method, apparatuses, and/or non-transitory computer-readable medium described above, the one or more operating conditions include states for one or more peripheral devices, and the one or more peripheral devices include at least one of a camera, a microphone, a speaker, a Bluetooth network device, a wireless network device, a display, a memory card, an internal memory, a gyroscope, an accelerometer, a global positioning system (GPS) receiver, or a combination thereof. The one or more peripheral devices may be peripheral devices internal to the mobile computing device. The one or more peripheral devices may be the camera, and the security inconsistency may include the current state of the camera being enabled and the secured state of the camera being disabled.

In some examples of the described methods, issuing the notification may include one or more of outputting an auditory alert, outputting a visual alert, vibrating the mobile computing device, or a combination thereof. The described apparatuses and/or non-transitory computer-readable medium may include instructions executable by a processor for performing these features.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system, in accordance with various aspects of the present disclosure.

FIG. 2 illustrates a flow diagram for mobile device provisioning using a mobile device provisioner, in accordance with various aspects of the disclosure.

FIG. 3 shows a conceptual diagram of an example mobile communication device responding to received malware, in accordance with various aspects of the present disclosure.

FIG. 4 shows a conceptual diagram of an example mobile communication device providing a notification of a security inconsistency, in accordance with various aspects of the present disclosure.

FIG. 5A shows a conceptual diagram of an example of a mobile device hardware and software stack, in accordance with various aspects of the present disclosure.

FIG. 5B shows a diagram of an application framework, which may be the application framework of HW/SW stack of FIG. 5A, in accordance with various aspects of the present disclosure.

FIG. 6 shows a block diagram of an example of an apparatus for use in mobile communication device security, in accordance with various aspects of the present disclosure.

FIG. 7 shows a block diagram of a mobile communication device configured to provide security, in accordance with various aspects of the present disclosure.

FIG. 8 is a flowchart of an example method for providing a notification of a security inconsistency, in accordance with various aspects of the present disclosure.

FIG. 9 is a flowchart of an example method for taking corrective action in response to a security inconsistency, in accordance with various aspects of the present disclosure.

FIG. 10 is a flowchart of an example method for detecting a state change for a peripheral device of a mobile computing device, in accordance with various aspects of the present disclosure.

### DETAILED DESCRIPTION

Described embodiments are directed to methods, apparatuses, systems, and devices for providing notifications of security inconsistencies for mobile computing devices. In one example, methods, apparatus, systems, and devices are described that provide a notification of a conflict between an operating condition of a mobile computing device and a secured state defined in security policies provisioned for the mobile computing device. For example, a mobile computing device may be configured with security policies that define one or more secured states of one or more peripheral devices, a whitelist of allowed applications, a blacklist of prohibited applications, and/or firewall security settings of the mobile computing device. If the mobile computing device is connected to a network, such as the Internet, there is a possibility that the mobile computing device could be infected with malware or other software that could make a change to the mobile computing device operating conditions that conflicts with the security policies. The mobile computing device may include a security client that monitors one or more operating conditions and if a state of an operating condition is inconsistent with the secured state, the security client may issue a notification indicating that a the state has been changed. The security client may also perform, automatically upon detection of the change that conflicts with the security policies, an action to mitigate the security inconsistency.

By monitoring the states of operating conditions of the mobile computing device and issuing notifications when a security inconsistency is detected, the security of the mobile computing device may be improved. For example, if a mobile computing device is infected with malware that turns on a peripheral device in order to gather information, such as turning on a camera, the security of the mobile computing device and/or its user may be compromised. In examples described herein, the security client may detect the change in state of the camera of the mobile computing device and notify the user upon detection of the change. The notification may also provide the user with options to, for example, block the state change, revert the state back to the original state, and/or notify an IT administrator of the state change. The security client may also be configured to automatically take corrective action to resolve the security conflict, such as disabling the camera. In this manner, the state of the peripheral can be corrected and the mobile computing device can be protected before additional information is gathered.

Conventional systems may lock down a mobile computing device and have an information technology (IT) administrator attempt to monitor all the corporate devices via a remote connection. Unfortunately, locking down the mobile computing device may not always be successful. Further, an administrator can fail to notice the issue quickly or may not even notice the issue at all due if the malware prevents a message to the administrator or prevents any indications of changes to the mobile computing device from being apparent at the remote connection. By the time the user or administrator is able to participate in the security process, the harm may already be done to the user, the mobile computing device, and/or a local network and any other devices connected to the local network.

In contrast, techniques described herein may provide an auditory, visual, and/or physical notification of a security inconsistency at the mobile computing device where the security inconsistency is detected. The mobile computing device may provide the notification within a short time after detecting the security inconsistency. The techniques described herein provide the user with an opportunity to react to possible malware that is causing the security inconsistency. Some examples may further provide one or more notifications to a network administrator and may require an administrator to react to the possible malware on the mobile computing device.

Thus, the following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments. Further features described with respect to certain embodiments may be omitted from those embodiments.

Mobile computing devices are becoming increasingly important for business communications and productivity. Mobile computing devices may include, for example, smartphones, tablets, wearable computing devices (e.g., smart watches, head-mounted computing systems, etc.), and the like. Generally, mobile computing devices utilize a mobile operating system (OS) and support mobile communications connectivity such as wireless wide area network (WWAN) and/or wireless local area network (WLAN) connectivity. For example, smartphones may generally include functionality for performing communications (e.g., voice, data, short messaging service (SMS), etc.) over one or more cellular WWAN networks using radio communication technologies such as Code Division Multiple Access (CDMA), Wideband Code Division Multiple Access (W-CDMA), Long-Term Evolution (LTE), LTE-Advanced (LTE-A), and the like. Mobile operating systems typically also include support for other communication interfaces such as WLAN communications (e.g., Wi-Fi, etc.). Examples of mobile OSs include the Android OS, Apple's iOS, Microsoft's Windows Phone OS, and the like.

Generally, mobile computing devices utilize WWAN and/or WLAN interfaces for network connectivity (e.g., Internet Protocol (IP) communications, etc.), meaning that the mobile computing device is networked through these interfaces for communications on private or public networks (e.g., the Internet, etc.). For mobile computing devices intended to be used to access corporate networks, secure communications (e.g., virtual private network (VPN) sessions, etc.) may be supported to allow the device to access data on the corporate networks.

Mobile computing devices running mobile operating systems may support additional communication interfaces which are generally not used for network communications. For example, mobile computing devices may support wired interfaces such as universal serial bus (USB), Firewire (IEEE 1394), and/or Lightning, and wireless interfaces such as Bluetooth, infrared communications, or near-field communication (NFC). Interfaces such as USB, Bluetooth, infrared, and NFC are generally used for local communications such as a personal area network (PAN), which allows certain other devices (e.g., headsets, speakers, wearable technology, etc.) to be connected to the mobile computing device for certain purposes. In addition, wired interfaces may typically be used to synchronize a mobile computing device with files (e.g., music library, etc.) on a computer.

In addition, mobile operating systems support peripheral devices integrated into the device including, for example, a touchscreen, global positioning system (GPS) receiver for mobile navigation, one or more cameras (e.g., still, video, etc.), dedicated digital signal processor (DSP) (e.g., for speech recognition and the like), and other features. Generally, the term “peripheral device,” as used herein, refers to hardware coupled to a mobile communication device and used to support user features of the mobile communication device. While the present description generally discusses such peripheral devices as integrated within the mobile computing device, peripheral devices can also be external devices coupled to the mobile computing device.

Because of the high level of connectivity provided by mobile computing devices, these devices can provide an attractive target for hacking and malware. Common forms of attack on mobile computing devices include social engineering attacks to convince device users to install malware, attacks on third-party applications, attacks on security used for communications, fake or malicious base stations or Wi-Fi access points, and the like. Some of the threats attempt to turn on peripherals or install applications in order to gather information for malicious purposes such as obtaining access to financial accounts.

When corporations provide and support mobile computing devices, attacks on the devices can pose serious risks for loss of confidential information or unauthorized access to confidential communications. Because mobile computing devices support a broad range of peripherals, applications, and features, some attacks attempt to utilize these peripherals, applications, or features to gain access to confidential information.

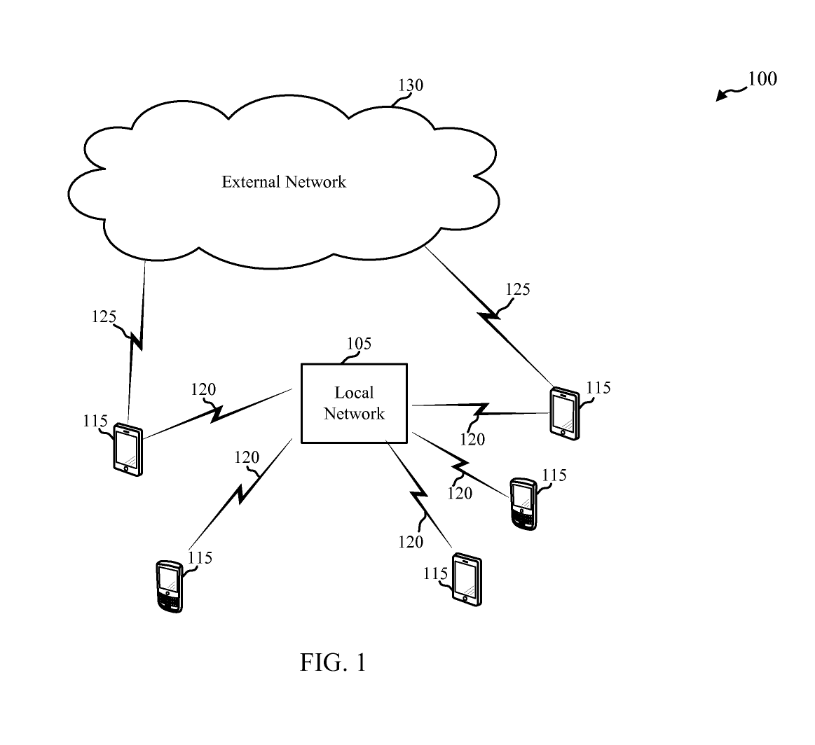

FIG. 1 shows a block diagram of a wireless communications system 100, in accordance with various aspects of the present disclosure. The wireless communication system 100 may include a local network 105, mobile computing devices 115 (also referred to herein as “mobile devices”), and an external network 130. The mobile devices 115 may communicate with the local network 105 over wired or wireless communication links 120, which may be secure communication links (e.g., wired links, secured wireless intranet, etc.). The mobile devices may communication with the external network 130 over communication links 125, which may be considered to be unsecure (e.g., public Wi-Fi, etc.).

In one example, the local network 105 may be a local network for a group of mobile devices 115 associated with a corporation. The local network 105 may be an Intranet, an IP

Multimedia Subsystem (IMS), and/or a Packet-Switched (PS) Streaming Service (PSS), or another type of network. For example, the local network 105 may include various networks and services associated with a corporation including Intranets, databases, communication servers (e.g., email servers, etc.), and the like. The corporation may distribute the mobile devices 115 to its employees and the employees may access the networks and services of the local network 105 using the mobile devices 115 via secure communication links 120 or other communication links 125 (e.g., via external network 130). For example, the mobile devices 115 may be configured to access the local network 105 via external network 130 using secure communication protocols such as virtual private networking, secure email protocols, and the like. Such secure communication protocols may utilize encryption (e.g., public key infrastructure (PKI), etc.) based on communication certificates issued to the mobile devices 115. The mobile devices 115 may also be provided with one or more security workspaces or containers (e.g., KNOX container, etc.) that provide for security checks (e.g., kernel validation, etc.) for data access.

An IT administrator may provision each mobile device 115 for use in a manner that maintains security of data and communications with the local network 105. The IT administrator may use a device provisioning system, which may include software and hardware (e.g., a personal computer (PC), wired or wireless interfaces, etc.). In one example, the software may be known as Exede Dynamic Defense (EDD), and may include functionality for configuring, provisioning, monitoring and auditing security on the mobile devices 115, and may be specifically designed for an IT administrator to use. This software may be an application, such as a Windows desktop application, that allows the IT administrator to define security policies, applications, configuration files, and certificates to be installed on the mobile device 115. Once the IT administrator defines the settings within EDD, the IT administrator may connect the mobile device 115 via a local wired or wireless interface (e.g., USB, Thunderbolt, Bluetooth, NFC, Wi-Fi, etc.) to the PC. When the PC detects the device, the software (e.g., EDD) may configure and provision the mobile device 115, which may include pushing configuration and security client files over to the mobile device 115.

The external network 130 may be an operator network such as a WWAN network or local area network (LAN), providing connectivity to the local network 105 (e.g., via other networks such as the Internet, etc.). In various instances, the provisioned mobile devices 115 may access the local network 105 via the external network 130. For example, as mobile devices 115 are used in various locations, connectivity to the local network 105 may be provided via the external network 130. However, the external network 130 may not be considered to be a secure network for the provisioned mobile devices 115. For example, various entities and/or interconnections in the external network 130 may not be secure or may be untrusted. In some instances, these entities and/or interconnections may provide entry points for unauthorized or malicious attack vectors to gain access to the mobile device 115. For example, an attacker, such as a person or malicious process, may access one of the mobile devices 115 and infect the mobile device 115 with malware. The attacker may attempt to retrieve information from the mobile device 115. One method of getting information from the mobile device 115 may be to activate one or more peripheral devices that were previously turned off (i.e., resulting in a state change of the peripheral device), such as a camera or a microphone. Using these peripheral devices, the attacker may obtain information about the surroundings of the mobile device 115 and also potentially about a user of the mobile device 115. In other cases, a user of a provisioned mobile device 115 may install an application that, unknown to the user, harbors an attack vector such as malware. In yet other cases, a user of a provisioned mobile device 115 may access, knowingly or unknowingly, an entity such as a website that may attempt to gain access to the provisioned mobile device 115. In addition, if a current state of a peripheral device (e.g., ON) does not match the security policies of the device, it may indicate that an attack vector has been able to infiltrate the secure operation of the mobile device 115. Thus, even if operation of the peripheral device is not a current security threat, it may indicate that other secure areas of the mobile device 115 are compromised.

The described embodiments include a security client for a mobile device 115 that monitors and detects inconsistencies of operating conditions of the mobile device 115 according to security policies for the mobile device 115. When an operating condition is detected that conflicts with the security policies of the mobile device 115, the security client may perform one or more response actions also referred to herein as “actuations.” The response actions may include notification of the user or a network administrator of the potential security breach. A user notification may provide the user with an opportunity to select an action to take in response to the potential security breach. Additionally or alternatively, the response actions may include an actuation associated with the detected inconsistency. Such actuations include uninstalling an application, setting the operating condition to the secured state, blocking a data transfer, erasing data stored by the mobile device 115, locking the mobile device 115, rebooting the mobile device 115, blocking access to data containers, blocking at least one inter-process communication (IPC) connection, blocking hardware signals (e.g., interrupts, etc.), blocking data transfers to and/or from memory, blocking input/output from peripherals, blocking software interrupts, blocking system calls, blocking traps, erasing data containers, locking data containers, and the like. The security client may maintain associations between operating condition inconsistencies and notifications and/or actuations to be performed. The associations may be configurable by the IT administrator using a mobile device provisioning tool (e.g., EDD, etc.). The security policies may include security policies associated with hardware peripheral use, an application whitelist, an application blacklist, and/or firewall security settings. The security policies may be maintained by the security client in a portion of the mobile OS address space (e.g., application sandbox, etc.) apart from the mobile OS management of peripheral devices, application installation, and/or network operation.

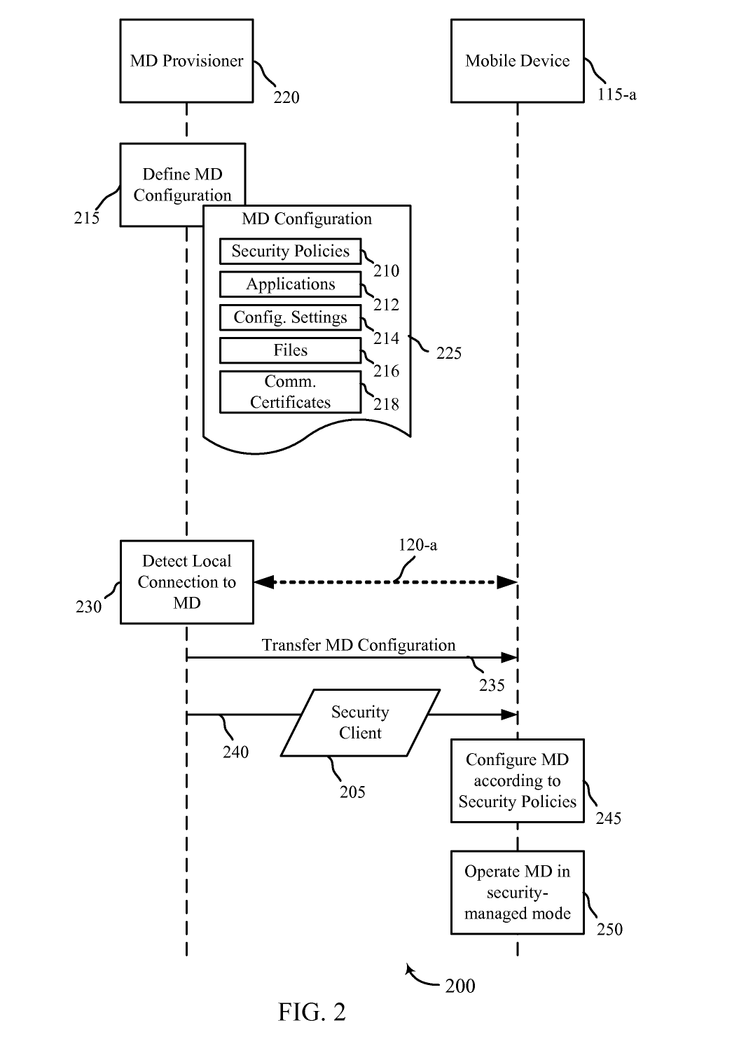

FIG. 2 illustrates a flow diagram 200 for mobile device provisioning using mobile device provisioner 220, in accordance with various aspects of the disclosure. Mobile device provisioner 220 may be, for example provisioning software such as EDD. Mobile device provisioner 220 may be an application running on a local computer (e.g., computer connected to local network 105 via a secure connection).

At block 215, the mobile device provisioner 220 may be used to define a mobile device (MD) configuration 225. For example, the mobile device provisioner 220 may have a set of predefined security policies 210, applications 212, configuration settings 214, files 216, and/or communication certificates 218 for provisioning mobile devices 115. Additionally or alternatively, mobile device provisioner 220 may accept user input from an IT administrator to select security policies 210, applications 212, configuration settings 214, files 216, and/or communication certificates 218 for provisioning mobile devices 115. In some examples, the mobile device configuration 225 may be a saved configuration including a set of predefined security policies 210, applications 212, configuration settings 214, files 216, and/or communication certificates 218 for a particular corporate environment. Thus, the IT administrator may need not re-define the mobile device configuration 225 for each mobile device 115 configured with the mobile device provisioner 220.

Once the mobile device configuration 225 is defined, a mobile device 115-a may be connected to the local computer via interface 120-a. Interface 120-a may be a local interface or a remote interface, in some cases. Connecting the mobile device 115-a to the local computer over a local interface 120-a may include connecting a wired interface (e.g., USB, etc.) between mobile device 115-a and the local computer or establishing the connection over a proximity-based wireless interface (e.g., NFC, Wi-Fi, Bluetooth, Bluetooth LE, etc.) using one or more commands of the mobile device 115-a and local computer. Connecting the mobile device 115-a to the local computer over a remote interface 120-a may include establishing a secure connection (e.g., VPN session, etc.). In some examples, connecting the mobile device 115-a to the local computer may include configuring the mobile device 115-a in a media transfer protocol (MTP) mode.

At 230, the mobile device provisioner 220 may detect the presence of the mobile device 115-a. For example, the mobile device provisioner 220 may detect that the connected mobile device 115-a matches the device type to be provisioned, is not already provisioned, and/or is configured in media transfer protocol (MTP) mode.

At 235, the mobile device provisioner 220 may transfer the mobile device configuration 225 to the mobile device 115-a over the local interface 120-a. The mobile device configuration 225 may include security policies 210 that may establish the allowed uses of peripherals, application whitelist/blacklist, and the like. In some examples, establishing the connection between the local computer and the mobile device 115-a over a local interface using MTP mode allows the mobile device configuration 225 to be transferred to the mobile device 115-a as a set of files.

At 240, the mobile device provisioner 220 may transfer a security client 205 that may perform various security functions on the mobile device 115-a. In other examples, the security client 205 may be transferred to the mobile device 115-a in other manners. For example, the security client 205 may be downloaded from a distribution platform for applications for the mobile operating system of the mobile device 115-a (e.g., Google Play for Android, iTunes for Apple's iOS, etc.).

At 245, the security client 205 may configure the mobile device 115-a for operation according to the mobile device configuration 225 including security policies 210. For example, the security policies 210 may restrict usage for one or more peripherals. Restricting usage for one or more peripherals may include disabling the peripheral from being used. In other cases, restricting usage may mean that a peripheral can only be used by certain applications or have other time-based restrictions, location-based restrictions, or access control (e.g., password required for use, etc.).

In some examples, the mobile device 115-a (e.g., the mobile OS) may be operated in a security-managed mode as illustrated by block 250. For example, the security-managed mode may enable features such as a device password, automatic screen lock, a password failure retry policy, encryption (e.g., device encryption, media encryption, etc.), remote wipe, prevention of kernel modification, and the like. The security client 205 may apply and monitor the security policies 210 in the security-managed mode. For example, Android OS devices may be operated in a common criteria (CC) mode that enables features for secure operation for enterprise connectivity. The security client 205 may be configured to monitor the CC mode operation of the device and enforce the security policies 210 (e.g., lock down peripherals, perform security monitoring, enforce encryption requirements, manage secure connections, etc.).

The mobile device provisioner 220 may be used to configure additional mobile devices 115 by repeating blocks 230, 235, 240, and/or 245 with the additional mobile devices 115. In case any of the settings need changing in the future, the mobile device 115-a may provide an IT administrator capability to make modifications without the need to reset the mobile device 115. For example, the mobile device provisioner 220 may be used to update security settings for provisioned mobile devices (e.g., over a secure connection such as a secure communication link 120 or secure protocol on an unsecure communication link 125, etc.)

The security policies 210 may include, for example, security policies associated with hardware peripheral use, an application whitelist, an application blacklist, and/or firewall security settings. The hardware peripheral security policies may define one or more authorized states for one or more peripheral devices of the mobile device 115. The application whitelist may indicate applications that are allowed to be installed on the mobile device 115, and enabling of the application whitelist may indicate that applications not on the whitelist should not be allowed to be installed. Additionally or alternatively, the application blacklist may indicate applications that are not allowed to be installed, while applications not on the blacklist are allowed to be installed according to the security policies. The firewall security settings may indicate connections that are allowed or not allowed. For example, the firewall security settings may indicate network addresses (e.g., IP addresses, domain names, etc.) for which connections are trusted, allowed, or not allowed. The security client may monitor and detect any changes in operational state of the mobile device 115 inconsistent with the security policies. For example, the security client may monitor and detect state changes of peripheral devices, installed applications, and/or firewall operation. The security client may monitor the operational state of the mobile device 115 at multiple software levels (e.g., access control layer, service layer, etc.). If the security client detects a state change that is not authorized according to the security policies, the security client may issue a notification of the change to the user and/or perform an actuation associated with the detected state change.

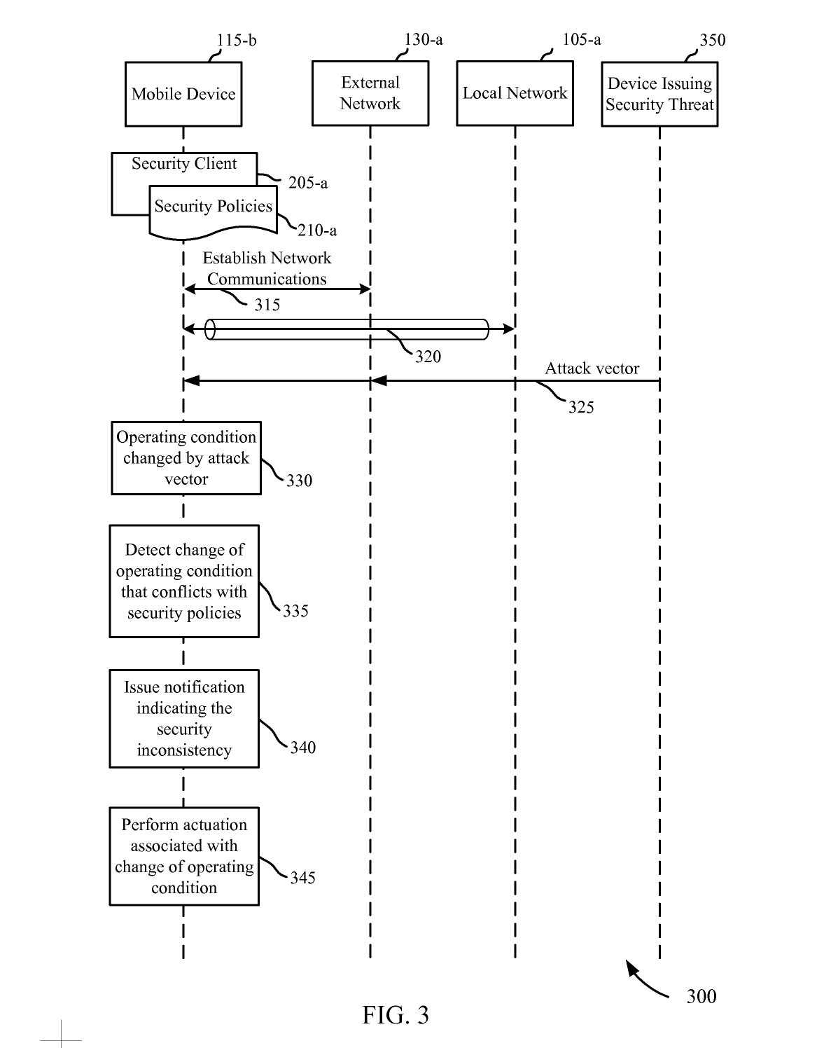

FIG. 3 shows a conceptual diagram 300 of an example mobile device 115-b responding to an attack vector 325, in accordance with various aspects of the present disclosure. The mobile device 115-b may be an example of aspects of one or more of the mobile devices 115 described with reference to FIG. 1 or 2. For example, the mobile device 115-b may be provisioned for a corporate enterprise using the device provisioner 220 of FIG. 2. The mobile device 115-b may communicate with an external network 130-a and/or a local network 105-a. In some examples, the local network 105-a and the external network 130-a may be examples of aspects of the local network 105 and/or the external network 130 described with reference to FIG. 1.

Security client 205-a may be running on mobile device 115-b, which may run as an application and/or service of a mobile OS of the mobile device 115-b. For example, the security client 205-a may run whenever the mobile device 115-b is turned on. The security client 205-a may be an example of the security client 205 of FIG. 2. The security client 205-a may contain a list of security policies 210-a that describe secure operating states of the mobile device 115-b. For example, the security policies 210-a may include security policies associated with hardware peripheral use, an application whitelist, an application blacklist, and/or firewall security settings. In some instances, the mobile device 115-b is run in a security-managed mode. The security client 205-a then monitors operating conditions of the mobile device 115-b during operations performed by the mobile device 115-b (e.g., user actions, communication messaging, etc.). The security client 205-a may monitor operating conditions of the mobile device 115-b by concurrently monitoring multiple software levels of the mobile device 115-b.

At block 315, the mobile device 115-b may establish network communications with the external network 130-a. For example, the mobile device 115-b may connect to a WWAN or WLAN network outside of the corporate premises. Once connected to the external network 130-a, the mobile device 115-b may establish one or more secure connections 320 (e.g., secure email sessions, VPN sessions, etc.) for communication with the local network 105-a via the external network 130-a.

While connected to the external network 130-a, the mobile device 115-b may be susceptible to security threats. For example, the mobile device 115-b may be addressable as a node on the external network 130-a, and therefore may be visible to malicious code or persons 350 associated with or connected to external network 130-a. In some instances, an attack vector 325 may gain access to some portions of mobile device 115-b. For example, attack vector 325 may install malware on the mobile device 115-b, through an inadvertent download, a user unsuspectingly clicking on a link, opening email messages with attachments, and the like. In other cases, attack vector 325 may include malicious instructions received through communications with other network entities such as web servers and the like. The attack vector 325 may attempt to do any number of harmful operations on the mobile device 115-b, such as control one or more peripheral devices of the mobile device 115-b, direct communications sent via secure connection 320 from the mobile device 115-b to an unsecure destination, install an application on the mobile device 115-b, send data from the mobile device 115-b to the attacker 350 (e.g., personal data, financial data, trade secrets, user names and passwords, etc.), and/or be controlled by the attacker 350 (e.g., turning the mobile device 115-b into a botnet). In some instances, confidential information stored on or accessible to mobile device 115-b, such as information communicated between the mobile device 115-b and the local network 105-a or information that can be detected by peripheral devices of the mobile device 115-b, may be compromised by the attack vector 325.

For companies that provide mobile devices 115 to employees, these types of attacks on provisioned mobile devices 115 may provide a high risk for the company's secure network infrastructure.

In the example of FIG. 3, the attack vector 325 is able to breach the security of the mobile device 115-b through external network 130-a. At block 330, the attack vector 325 causes a change in the operating conditions of the mobile device 115-b. For example, the attack vector 325 may install an application on mobile device 115-b, enable a hardware peripheral of the mobile device 115-b, direct communications to a malicious network entity, and the like.

Although illustrated as coming from attack vector 325 in FIG. 3, in some instances the user of the mobile device 115-b may intentionally perform actions that may change the operating conditions of the mobile device 115-b at block 330. For example, the user may enable a hardware peripheral, install an application, or direct communications to particular network entities. The user may be unaware that such actions may result in unsecure operating conditions for the mobile device 115-b. For example, the user may install an application that, not known to the user, carries the attack vector 325 or performs actions leading to unsecure operating conditions of the mobile device 115-b. In some instances, certain applications or actions that can be performed by the mobile device 115-b may not be unsecure, but may otherwise be prohibited by the enterprise IT administrator. For example, certain applications (e.g., games, etc.), although not malicious, may not be allowed to be installed on the corporate mobile devices 115. Additionally or alternatively, users may not be allowed to use certain hardware peripherals of the corporate mobile devices 115 or access certain network entities (e.g., certain web servers, etc.) using the corporate mobile devices 115.

At block 335, the security client 205-a may detect a change in operating conditions of the mobile device 115-b that is inconsistent with the security policies 210-a. For example, the security client 205-a may detect that a state of a hardware peripheral has changed. In one example, the security policies 210-a may indicate that a secured state of a hardware peripheral is the disabled state while the security client may detect that the hardware peripheral is enabled at block 335. In some instances, the secured state of the hardware peripheral may depend on factors related to device use or other states. For example, the security policies may authorize the camera to be used via a built-in camera application of the mobile device 115-b, but not used with any other applications. Thus, a security inconsistency may be detected if a non-authorized application attempts to access the camera peripheral. In other instances, other device factors may be used to determine the secured state of hardware peripherals. For example, the secured state of hardware peripherals may be dependent on device location, type of user authentication (e.g., passcode, fingerprint, etc.), time of day, day of week, and/or other factors.

The security client 205-a may issue a notification at block 340 indicating a security inconsistency has been detected. For example, the security client 205-a may (e.g., via the mobile OS, etc.) output a visual, audible, and/or physical notification of the security inconsistency event detected at 335. The notification may inform the user of a potential security breach. Notifying the user to a potentially harmful event may help to mitigate potential security risks of using the mobile device 115-b. Additionally or alternatively, the notification may present one or more user-selectable actions to be performed in response to the change in operating conditions detected at 335. For example, the notification at block 340 may present user-selectable options related to the change in operating conditions. In some examples, the options may include accepting the change in operating conditions, reverting to the secured state, notifying a system administrator, and the like. In some examples, the security policies 210-a may indicate that certain actions should trigger a notification that requires acceptance and/or authorization of the change in operating conditions by the user and/or IT administrator or certain actions do not trigger a notification. For example, the security policies 210-a may indicate that changes in operating conditions such as enabling a hardware peripheral, installing an application, and/or certain types of communication require the user to accept the change in operating conditions, re-authenticate (e.g., re-enter their user password, biometric authentication, etc.), and/or receive an authorization by the IT administrator. The associations between operating condition inconsistencies and notifications may be configurable by the provisioning tool used by the IT administrator (e.g., EDD, etc.).

In some instances, the notification may enable the user to take actions in instances where the security client 205-a or mobile OS may not be able to. For example, the user may stop performing a particular set of actions that compromise security (e.g., accessing a particular website, etc.).

Additionally or alternatively, the security client 205-a may automatically perform one or more actuations at block 345 based on detecting the security inconsistency. For example, the security client 205-a may (e.g., via the mobile OS, etc.) change the state of the peripheral device to the secured state as defined by the security policies 210-a. Other actuations that may be performed by the security client 205-a include notifying the IT administrator, uninstalling an application, setting the operating condition to the secured state, blocking a data transfer, erasing data stored by the mobile device 115-b, locking the mobile device 115-b, rebooting the mobile device 115-b, blocking access to data containers, blocking an IPC connection, blocking hardware signals (e.g., interrupts, etc.), blocking data transfers to and/or from memory, blocking input/output from peripherals, blocking software interrupts, blocking system calls, blocking traps, erasing data containers, locking data containers, and the like. The security client 205-a may maintain associations between operating condition inconsistencies and notifications and/or actuations to be performed. The associations between operating condition inconsistencies and actuations may be configurable by the provisioning tool used by the IT administrator (e.g., EDD, etc.).

In some embodiments, the security client 205-a may update the security policies 210-b based on the user electing to override the security inconsistency detected at 335. For example, the security policies 210-b may include some policies that can be configured by the user and some policies that can only be configured by the IT administrator. In one example, a feature such as a hardware peripheral may be associated with user-configurable security policies and administrator configurable policies. In one example, the user-configurable policies may include an application whitelist while the administrator-configurable policies may include an application blacklist. Thus, a hardware peripheral such as a camera may not trigger a security inconsistency if controlled by an application on the application whitelist, may trigger a user-selectable option to allow use if controlled by an application not on the whitelist or blacklist, and trigger a security inconsistency that the user is not able to override if controlled by an application on the blacklist.

In some embodiments, the security client 205-a may employ adaptive detection of security inconsistencies. For example, the security client 205-a may store user selections in response to notifications and use patterns of user input to detect whether changes in operating conditions trigger notification and/or performing actuations. In one example, the user may indicate in response to notification 340 that a particular use of a hardware peripheral (e.g., associated with a particular application, etc.) such as a camera was an authorized or intended use. The security client 205-a may then allow future similar use of the hardware peripheral (e.g., add the controlling application to the user-configurable whitelist, etc.) without triggering the notification 340 or actuation 345.

The security client 205-a may run autonomously or semi-autonomously from an enterprise security server or IT administrator. For example, security policies 210-a may be stored locally on the mobile device 115-b and the security client 205-a may perform some or all of the monitoring, detecting, notification, and/or actuations described above without communicating with a corporate server or computer associated with mobile device security management. In some cases, the security client 205-a may detect changes of operating conditions at block 335 even when not connected to a network (e.g., not connected to local network 105-a or external network 130-a, etc.).

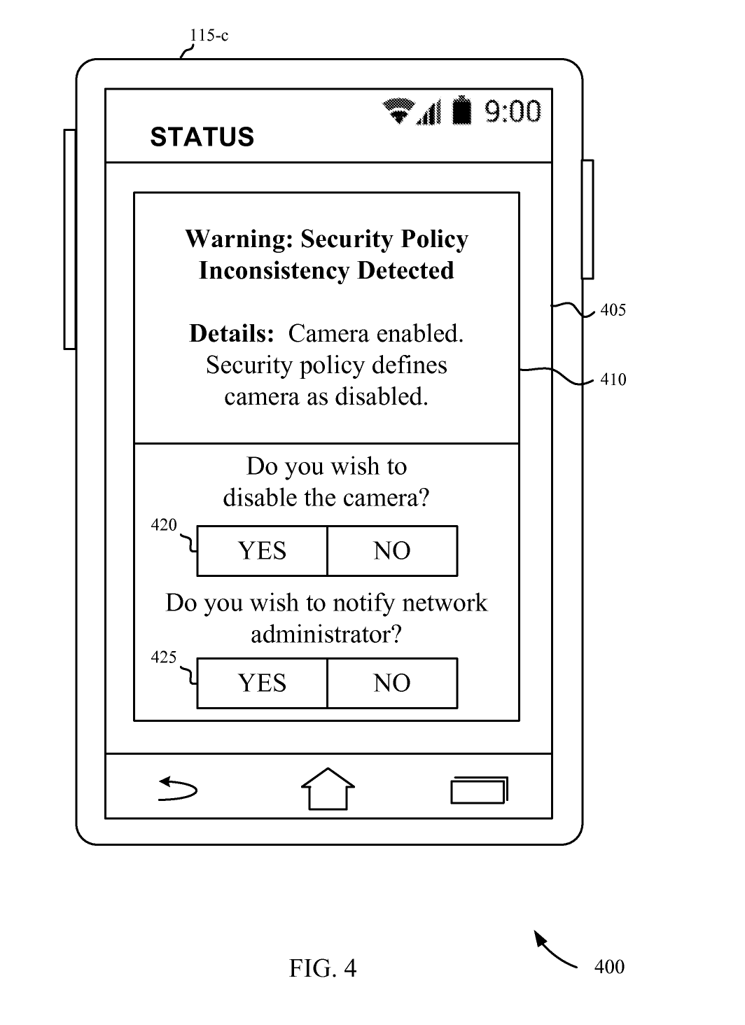

FIG. 4 shows a conceptual diagram 400 of an example mobile device 115-c providing a notification 410 of a security inconsistency, in accordance with various aspects of the present disclosure. The mobile device 115-c may be an example of aspects of one or more of the mobile devices 115 described with reference to FIGS. 1-3. The mobile device 115-c may include a security client (not shown) that performs monitoring of operating conditions of the mobile device 115-c according to security policies 210 (not shown).

The mobile device 115-c includes a user interface device (UID) 405. The UID 405 of the mobile device 115-c may function as an input device and as an output device for the mobile device 115-c. The UID 405 may be implemented using various technologies. For instance, the UID 405 may function as an input device using a presence-sensitive input display, such as a resistive touchscreen, a capacitive touchscreen, a surface acoustic wave touchscreen, a pressure sensitive screen, a projective capacitance touchscreen, an acoustic pulse recognition touchscreen, or another presence-sensitive display technology. The UID 405 may function as an output (e.g., display) device using any one or more display devices, such as a liquid crystal display (LCD), dot matrix display, light emitting diode (LED) display, organic light-emitting diode (OLED) display, e-ink display, or similar monochrome or color display capable of outputting visible information to the user of the mobile device 115-c.

The UID 405 of the mobile device 115-c may include a presence-sensitive display that may receive tactile input from a user of the mobile device 115-c. The UID 405 may receive indications of the tactile input by detecting one or more gestures from the user of the mobile device 115-c (e.g., the user may touch or point to one or more locations of the UID 405 with a stylus pen or a finger). The UID 405 may present output to the user via a graphical user interface (e.g., user interface 410) which may be associated with functionality provided by the mobile device 115-c. For example, the UID 405 may present various user interfaces of applications executing on or accessible via the mobile device 115-c (e.g., an electronic message application, an Internet browser application, a navigation application, a media player application, etc.). The user may interact with a respective user interface of an application to cause the mobile device 115-c to perform operations relating to a function.

In the example of FIG. 4, the security client may output, via UID 405 a security inconsistency notification 410. The security client may output the security inconsistency notification 410 in response to detecting a security inconsistency (e.g., state change of a peripheral device, installation of an application, communication messaging state, etc.) associated with the operating conditions of the mobile device 115-c. The security inconsistency notification 410 may provide a visual notification to a user of the mobile device 115-c that a security inconsistency was detected.

The security inconsistency notification 410 may output graphical elements, such as textual characters, indicating the security client has detected a security inconsistency. As illustrated in FIG. 4, the security inconsistency notification 410 includes the language

“Warning: Security Inconsistency Detected.” This may inform the user that a change in operating conditions of the mobile device 115-c is inconsistent with the security polices for the mobile device 115-c. For example, a peripheral device (e.g., camera, etc.) may be in an operating state that is different than a secured state of the peripheral device. The security inconsistency notification 410 may further provide details regarding the detected security inconsistency. In this example, the security inconsistency notification 410 further describes “Details: Camera enabled. Security policy defines camera as disabled.” A security inconsistency notification 410 may be displayed in any suitable manner, including different formats, information, color, number and quality of visual elements, and the like. Additionally or alternatively, security inconsistency notification 410 may include an auditory or tactile alarm (e.g., sounds, vibration) and/or other types of notification.

In some examples, the security inconsistency notification 410 may also output one or more graphical elements that provide options for the user to react to the detected security inconsistency. The graphical elements may be associated with user-selectable actuations. For example, the security policies may designate user-selectable actuations for associated with detected security inconsistencies. In the example shown in FIG. 4, the security inconsistency notification 410 outputs graphical elements 420 and 425. The graphical element 420 may provide the user of the mobile device 115-c with an option to disable the camera. The user may select Yes or No by interacting with graphical element 420 (e.g., by touching the area of the security inconsistency notification 410 for a portion of the graphical element 420 associated with the desired response, by making a gesture near the area of the graphical element 420 associated with the desired response, etc.). The graphical element 425 may provide the user of the mobile device 115-c with an option to notify their network administrator. The user may select Yes or No by interacting with graphical element 425. The mobile device 115-c may follow the instructions provided by the user based on the user's interactions with the graphical elements 420 and 425.

Other examples may present the user with different options in response to the detected security inconsistency. In yet other examples, the mobile device 115-c may not provide the user with options to react to the detected security inconsistency. Further, the mobile device 115-c may output other types of notifications besides, or in addition to, a visual notification. Such notifications may include an auditory notification that outputs one or more sounds indicating the detected security inconsistency, a physical notification such as a vibration, or other types of notifications.

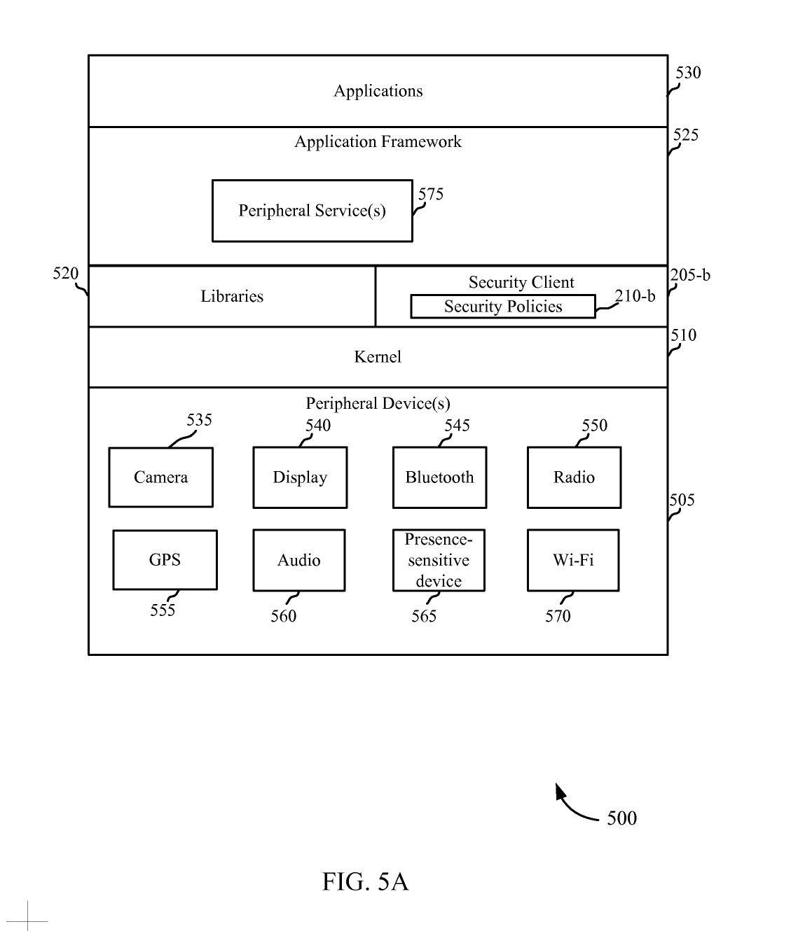

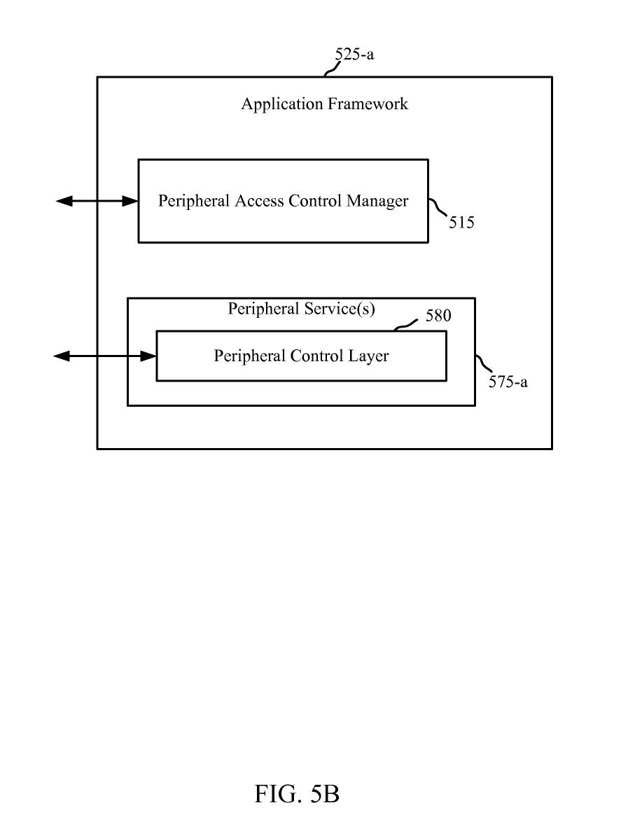

FIG. 5A shows a conceptual diagram of an example of a mobile device hardware (HW) and software (SW) stack 500, in accordance with various aspects of the present disclosure. A mobile device HW/SW stack 500 may describe different conceptual layers of a mobile device 115 and/or mobile OS architecture. The mobile device HW/SW stack 500 may be implemented in a mobile device, such as mobile devices 115 described with reference to any of FIGS. 1-4. The mobile device HW/SW stack 500 may be configured to implement at least some of the features and functions described with reference to any of FIGS. 1-4.

The mobile device HW/SW stack 500 may include hardware features and the mobile OS, including the kernel, middleware, libraries, and key applications that may work together to perform functions of a computing device, such as a mobile device 115. The mobile device HW/SW stack 500 may include hardware such as one or more peripheral devices 505 and/or computing elements such as a processor, storage, and memory (not shown). The peripheral devices 505 may include, for example, one or more cameras 535, one or more display devices 540, a Bluetooth interface 545, one or more radio transceivers 550, one or more GPS devices 555, one or more audio devices 560, one or more presence-sensitive devices 565, and/or one or more Wi-Fi radios 570. In other examples, the peripheral devices 505 include a subset of the devices shown in FIG. 5. In yet other examples, the peripheral devices 505 include a subset of the devices shown in FIG. 5 in addition to other devices not illustrated in FIG. 5.

The mobile device HW/SW stack 500 also includes a kernel 510. The kernel 510 may perform execution of operating system instructions and may provide (e.g., via libraries 520, etc.) an abstraction layer for other software layers of the mobile device HW/SW stack 500. The kernel 510 may be, for example, a Linux kernel, a Windows kernel, and the like. The kernel 510 may interact with the peripheral devices 505 and may include the hardware drivers for the peripheral devices 505. The kernel 510 may use the drivers to control and communicate with the peripheral devices 505. The kernel 510 may perform functions related to memory management, process management, networking, application of security settings, and other functions of the mobile device.

The mobile device HW/SW stack 500 also includes one or more libraries 520. The libraries 520 may enable the mobile device to handle different types of data. Example elements in the libraries 520 may include a surface manager, a media framework, a database engine, a browser engine, and a graphics rendering engine, for example. The kernel 510 may utilize the one or more libraries 520 in performing functions of the mobile device.

The mobile device HW/SW stack 500 may further include an application framework 525 and applications 530. The application framework 525 works with the libraries 520 to provide basic functionality to the applications 530. For example, the application framework 525 may provide resource management, activity life cycle management, manage data sharing between two or more applications 530, provide location management, and the like. The applications 530 provide end-user functionality for the mobile device, such as a web browser, phone functionality, email, calendar features, and the like.

The application framework 525 may include peripheral services 575, which may provide a hardware abstraction layer for the peripheral devices 505. For example, a peripheral service 575 may be used to control settings and operation of a peripheral device 505, or send data to or retrieve data from the peripheral device 505.

A security client 205-b of the mobile device HW/SW stack 500 may function as a service or runtime module. The security client 205-b may monitor and detect changes in operating conditions of the mobile device HW/SW stack 500. For example, the security client 205-b may monitor installed applications 530, peripherals 505, and/or communication interfaces of the mobile device HW/SW stack 500. In some examples, the security client 205-b monitors peripherals 505 by connecting (e.g., via peripheral service(s) 575) to services, classes, and/or an application programming interface (API) that manages the peripheral hardware 505. The security client 205-b may be an example of aspects of the security clients 205 of FIG. 2 or 3. The security client 205-b may include security policies 210-b, which may be stored separately from the kernel-level security policies of kernel 510. Security policies 210-b may be an example of security policies 210 of FIG. 2 or 3.

The security client 205-b may work with the other modules of mobile device HW/SW stack 500 to perform security management and monitoring. For example, the kernel 510 may receive instructions from the security client 205-b for secured states of the mobile device HW/SW stack 500. In some cases, the kernel 510 operates in a security-managed mode that may enforce kernel-level security settings (e.g., lock down peripherals, perform security monitoring, enforce encryption requirements, manage secure connections, etc.). While security management may be part of the kernel 510, including prevention of running malicious instructions or actions inconsistent with the kernel-level security settings, attacks may be able to circumvent the kernel-level security settings. For example, while the kernel 510 may control hardware peripherals to be in secured states via libraries 520, other mechanisms for connecting to and enabling hardware peripherals may exist including shared memory communications, direct communication to the device drivers, and the like. Because built-in security software is, therefore, not impenetrable, the security client 205-b enhances device security by storing security policies 210-b separate from the kernel 510. For example, the security policies maintained by the security client 205-b may be in a private memory space (e.g., KNOX container, application sandbox, etc.) and inaccessible to potential security threats. Storing security policies 210-b in a private memory space separate from the kernel may therefore maintain a record of the configured security states for the mobile device 115 even where the kernel-level security settings have been circumvented. Thus, the security client 205-b may be able to detect a security breach even when the kernel 510 may not be aware that the security breach has occurred.

The security client 205-b monitors operating conditions of the mobile device HW/SW stack 500 and performs notifications and/or actuations when a security inconsistency is detected. The security client 205-b may perform the notifications and/or actuations autonomously or semi-autonomously (e.g., even when not able to establish communication with an enterprise security server or IT administrator, or when no network connection is available, etc.). Notifications provide a method for the user to become aware of the security situation of the mobile device HW/SW stack 500 rather than just trying to secure the end point. The notifications may take the form of a physical, visual, and/or auditory notification of the discrepancy. When the user receives the notification, the user may be able to take action, such as removing the application, notifying an administrator, and/or reformatting the mobile computing device.

The security client 205-b may monitor the operational state of the mobile device 115 by monitoring or checking operational state at multiple software levels of the HW/SW stack 500. For example, the security client 205-b may monitor operational states of peripherals 505 at multiple levels of HW/SW stack 500.

FIG. 5B shows a diagram of application framework 525-a, which may be the application framework 525 of HW/SW stack 500 of FIG. 5A, in accordance with various aspects of the present disclosure. Application framework 525-a includes peripheral access control manager 515 and peripheral services 575-a. Peripheral services 575-a may be an example of peripheral services 575 of FIG. 5A, and may be associated with one or more of the peripheral devices 505.

Peripheral access control manager 515 may control access to the peripheral devices 505. For example, peripheral access control manager 515 may receive access control settings (e.g., from kernel 510 or security client 205-b) for the peripheral devices 505, which may specify authorized operational conditions, or applications that may be allowed access to the peripheral devices 505. Security client 205-b may set the access control settings based on the security policies 210 discussed above. Although illustrated as in the application framework 525-a, peripheral access control manager 515 may be a component of the kernel 510, in some cases.

Security client 205-b may monitor the configured access settings of peripheral devices 505 via the peripheral access control manager 515. For example, the security client 205-b may register with the peripheral access control manager 515 to be informed of access control changes to peripheral devices 505.

Security client 205-b may monitor the operational states of the peripheral devices 505 by monitoring additional software levels. For example, the security client 205-b may monitor the state of the peripheral devices 505 by communication with a peripheral control layer 580 of the peripheral services 575-a. For example, the security client 205-b may register with the peripheral control layer 580 to be informed of actual state changes of the peripheral devices 505. Additionally or alternatively, the security client 205-b may periodically check (e.g., via a class function or API call, etc.) the peripheral control layer 580 to determine the current state of the peripheral devices 505. Thus, where an attack vector is able to circumvent the access control provided by the peripheral access control manager 515 and change the state of one or more peripheral devices 505, the security client 205-b may still be able to detect that the operational state of the one or more peripheral devices 505 is not allowed by the security policies 210.

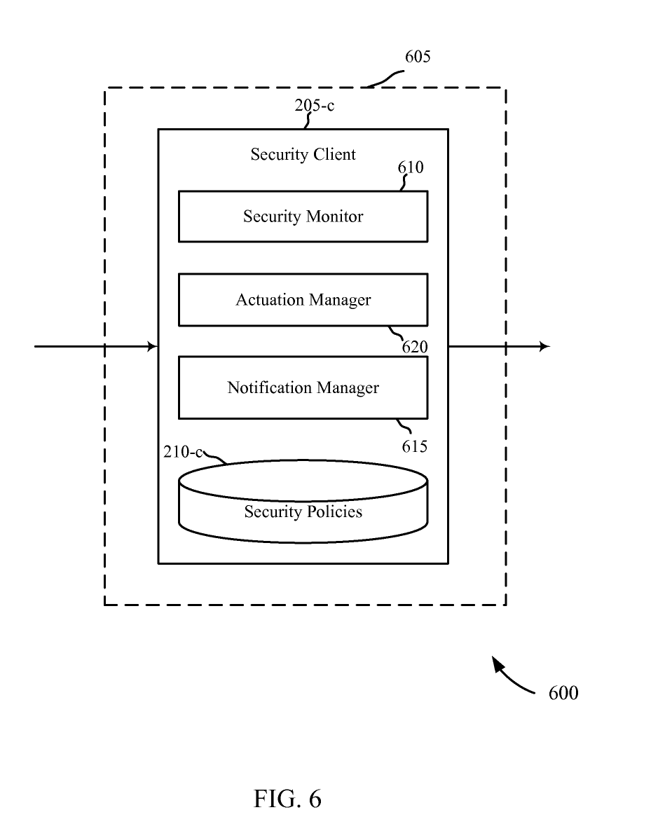

FIG. 6 shows a block diagram 600 of an example of an apparatus 605 for use in mobile device security. The apparatus 605 may be an example of aspects of the mobile devices 115 of FIGS. 1-4 and may include the mobile device HW/SW stack 500 of FIG. 5A. The apparatus 605 may be configured to implement at least some of the features and functions described with reference to any of FIGS. 1, 2, 3, 4, 5A, or 5B.

In some examples, the apparatus 605 may include a security client 205-c, which may be an example of aspects of one or more of the security clients 205 described with reference to FIG. 2, 3, or 5A. In some examples, the security client 205-c may include a security monitor 610, a notification manager 615, an actuation manager 620, and/or security policies 210-c. While FIG. 6 illustrates specific examples of the functions performed by each of the modules 610, 615, 620, and 210-c, the functions performed by each of the modules may in some cases be combined, divided, or implemented using one or more other modules.

The security client 205-c may run as an application and/or service of a mobile OS of the apparatus 605. For example, the security client 205-c may run whenever the apparatus 605 is turned on. The security client 205-c may include security policies 210-c that describe secure operating states of the apparatus 605. For example, the security policies 210-c may include security policies associated with hardware peripheral use, an application whitelist, an application blacklist, and/or firewall security settings. The security policies 210-c may be stored in a private portion of device storage and/or operating memory (e.g., application sandbox, etc.).

The security monitor 610 monitors operating conditions of the apparatus 605 during operations performed by the apparatus 605 (e.g., user actions, communication messaging, etc.). The security monitor 610 may detect a change in operating conditions of the apparatus 605 that is inconsistent with the security policies 210-c. For example, the security monitor 610 may detect that a state of a hardware peripheral has changed. In some instances, the secured state of the hardware peripheral may depend on factors related to device use or other states. In other instances, other device factors may be used to determine the secured state of hardware peripherals. For example, the secured state of hardware peripherals may be dependent on device location, type of user authentication (e.g., passcode, fingerprint, etc.), time of day, day of week, and/or other factors. Security monitor 610 may monitor operational conditions of the apparatus 605 at multiple software levels. For example, security monitor 610 may monitor an access control level (e.g., in an application framework or kernel of a mobile OS, etc.) for changes in access permission for a peripheral device and concurrently monitor a service level (e.g., of a peripheral service) for the current operational state of the peripheral device. When the security monitor 610 detects a security inconsistency, it may inform the notification manager 615 and actuation manager 620 of the security inconsistency.

The notification manager 615 may provide one or more notifications of the security inconsistency. The notifications may be outputted by one or more output devices of the apparatus 605. The notification may indicate to a user that hardware peripherals of the apparatus 605 are behaving outside of a desired compliance. The parameters of the desired compliance may be determined by security policies 210-c and/or other components of the apparatus 605 (e.g., access control manager, kernel, etc.). The notification manager 615 may provide a method for the user to become aware of the security situation of the apparatus 605. The notification manager 615 may provide a physical, visual, and/or auditory notification of any adverse hardware changes. For example, the notification manager 615 may provide notifications of discrepancies between the behavior of one or more peripheral devices and the behavior defined in the security policy for the one or more peripheral devices. When the user receives the notification, the user may be able to take action, such as removing the application, notifying an administrator, reverting the peripheral devices to states in compliance with the security policy, and/or reformatting the apparatus 605. The security policies 210-c may include associations of security inconsistencies with notification types, notification options (e.g., user selections, whether user override is allowed, etc.).

The actuation manager 620 may perform one or more actuations based on the detected security inconsistency. For example, the actuation manager 620 may change the state of the peripheral device to the secured state as defined by the security policies 210-c. Other actuations that may be performed by the actuation manager 620 include notifying the IT administrator, uninstalling an application, setting the operating condition to the secured state, blocking a data transfer, erasing data stored by the apparatus 605, locking the apparatus 605, rebooting the apparatus 605, blocking access to data containers, blocking an IPC connection, blocking hardware signals (e.g., interrupts, etc.), blocking data transfers to and/or from memory, blocking input/output from peripherals, blocking software interrupts, blocking system calls, blocking traps, erasing data containers, locking data containers, and the like. The security policies 210-c may maintain associations between operating condition inconsistencies and actuations to be performed. The associations between operating condition inconsistencies and actuations may be configurable by the provisioning tool used by the IT administrator (e.g., EDD, etc.).

The functions of the modules of apparatus 605 may be implemented, in whole or in part, with instructions embodied in a memory, formatted to be executed by one or more general or application-specific processors (e.g., CPUs, cores, etc.) of apparatus 605. For example, the modules of apparatus 605 may represent instructions embodied in one or more classes, modules, and/or packages that may be compiled to execute on the one or more processors or may be interpreted at run-time by the one or more processors. In other examples, various components of the apparatus 605 may, individually or collectively, be implemented in hardware using one or more application-specific integrated circuits (ASICs), Field Programmable Gate Arrays (FPGAs), and/or other Semi-Custom components or integrated circuits (ICs), which may be programmed (e.g., configured, synthesized from a hardware description language (HDL), etc.) in any manner known in the art.

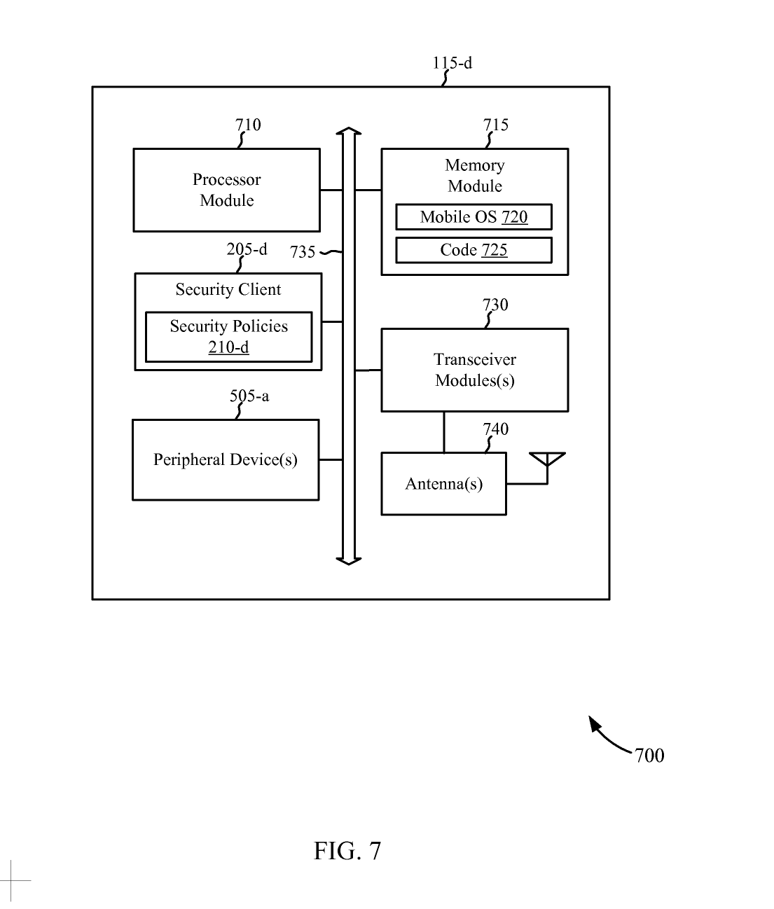

FIG. 7 shows a block diagram 700 of a mobile device 115-d configured to enhance enterprise security, in accordance with various aspects of the present disclosure. The mobile device 115-d may have various configurations and may be or be part of a cellular telephone, a smartphone, a tablet, a PDA, a digital video recorder (DVR), an internet appliance, a gaming console, an e-reader, or the like. The mobile device 115-d may, in some examples, have an internal power supply, such as a small battery, to facilitate mobile operation. In some examples, the mobile device 115-d may be an example of aspects of one or more of the mobile devices 115 described with reference to any of FIGS. 1-4 or aspects of mobile device HW/SW stack 500 of FIG. 5A or apparatus 605 of FIG. 6. The mobile device 115-d may be configured to implement at least some of the features and functions described with reference to any of FIGS. 1-6.

The mobile device 115-d may include a processor module 710, a memory module 715, at least one transceiver module (represented by transceiver module(s) 730), one or more antenna(s) 740), and/or one or more peripheral devices 505-a. Each of these components may be in communication with each other, directly or indirectly, over one or more buses 735.

The memory module 715 may include random access memory (RAM) and/or read-only memory (ROM). The memory module 715 may store at least a mobile OS 720. The mobile OS 720 may be built on a Linux or Windows kernel and may be, for example, an Android mobile OS, Apple iOS mobile OS, or Windows Phone mobile OS. The memory module 715 may also store computer-readable, computer-executable code 725 including instructions that are configured to, when executed, cause the processor module 710 to perform various functions described herein related to security monitoring and notification.

Alternatively, the code 725 may not be directly executable by the processor module 710 but be configured to cause the mobile device 115-d (e.g., when compiled and executed) to perform one or more of the functions described herein.

The processor module 710 may include an intelligent hardware device, e.g., a CPU, a microcontroller, an ASIC, or the like. The processor module 710 may process information received through the transceiver module(s) 730 and/or information to be sent to the transceiver module(s) 730 for transmission through the antenna(s) 740. The processor module 710 may handle, alone or in connection with the security client 205-d, various aspects of communicating over (or managing communications over) a radio frequency spectrum.

The transceiver module(s) 730 may include a modem configured to modulate packets and provide the modulated packets to the antenna(s) 740 for transmission, and to demodulate packets received from the antenna(s) 740. The transceiver module(s) 730 may, in some examples, be implemented as one or more transmitter modules and one or more separate receiver modules. The transceiver module(s) 730 may support wireless communication using one or more radio access technologies. The transceiver module(s) 730 may be configured to communicate bi-directionally, via the antenna(s) 740, with one or more of the local or external networks described with reference to any of FIGS. 1 and 3. While the mobile device 115-d may include a single antenna, there may be examples in which the mobile device 115-d may include multiple antennas 740.

The one or more peripheral devices 505-a may include any hardware internal to the mobile device 115-d and any external hardware communicatively coupled to the mobile device 115-d. Example peripheral devices 505-a may include one or more cameras, microphones, audio devices such as speakers, display devices such as a presence-sensitive screen, Bluetooth devices and transceivers, radio frequency transceivers including Wi-Fi transceivers, optical transceivers, Global Navigation Satellite System (GNNS) devices such as Global Positioning System (GPS) devices, sensors such as gyroscopes and accelerometers, 505!printers, motors, actuators, electromagnets, piezoelectric sensors, network interface cards, USB controllers, storage devices, or any other type of hardware device that can be part of or communicatively coupled with the mobile device 115-d. The peripheral devices 505-a may be susceptible to security attacks.

The security client 205-d may be configured to perform and/or manage some or all of the features and/or functions described with reference to any of FIGS. 1-6 related to provisioning the mobile device 115-d with the security policies 210-d, monitoring the mobile device 115-d for changes in operating conditions inconsistent with the security policies 210-d, notifying a user of the mobile device 115-d when a security inconsistency is detected, and/or performing an actuation when a security inconsistency is detected. The security client 205-d, or portions of it, may be performed by the processor module 710 and/or in connection with the processor module 710. In some examples, the security client 205-d may be an example of the security clients 205 described with reference to FIGS. 2, 3, 5A and/or 6.

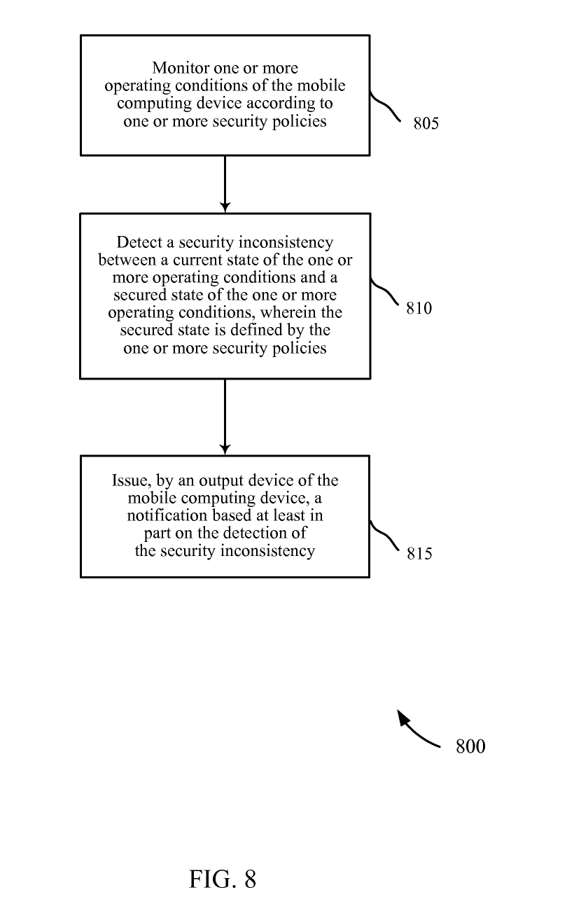

FIG. 8 is a flowchart of an example method 800 for providing a notification of a security inconsistency, in accordance with various aspects of the present disclosure. For clarity, the method 800 may apply to aspects of one or more of the mobile devices 115 described with reference to any of FIGS. 1-4 and/or 7, aspects of the HW/SW stack 500 of FIG. 5, or aspects of the apparatus 605 of FIG. 6. In some examples, a mobile device 115 or apparatus may execute one or more sets of codes to control the functional elements of the mobile device 115 or apparatus to perform the functions described below.

The method 800 may include monitoring one or more operating conditions of the mobile computing device according to one or more security policies at block 805. For example, a security client 205 as described with reference to FIGS. 2, 3, 5A, 6 or 7 may monitor state changes of peripheral devices, installed applications, and/or firewall operation. The peripheral devices may include a camera, a microphone, a speaker, a Bluetooth network device, a wireless network device, a display, a memory card, an internal memory, a gyroscope, an accelerometer, or a GPS receiver. The peripheral devices may be internal peripheral devices of the mobile device. The monitoring may include monitoring operational states of peripheral devices of the mobile device 115 at multiple software levels (e.g., access control level, service level, etc.). In some examples, the method 800 includes configuring the mobile device 115 according to a mobile device configuration comprising the one or more security policies, wherein states of the one or more peripheral devices are set to match secured states of the one or more peripheral devices defined by the mobile device configuration.

The method 800 may further include detecting a security inconsistency between a current state of the one or more operating conditions and a secured state of the one or more operating conditions, wherein the secured state is defined by the one or more security policies at block 810. For example, security inconsistencies may include installation of an application on an application blacklist, network communications inconsistent with firewall security policies, or a peripheral device that has a current state that is different from the secured state. In one example, the security inconsistency may be that the current state of the camera is enabled and a secured state of the camera is disabled.

The method 800 may also include issuing, by an output device of the mobile computing device, a notification identifying the detection of the security inconsistency at block 815. The notification may be a visual, auditory, or physical notification that indicates that a security inconsistency was detected. The output device may be a display device, a speaker, a vibrating motor, or the like. The notification may describe details about the security inconsistency, such as an application that has been installed, a type of network communication that has occurred, a type of adverse hardware change that occurred, what peripheral devices 505 were affected, and/or the identity of any malware detected. In some examples, issuing the notification may include outputting an auditory alert, outputting a visual alert, or vibrating the mobile computing device. In some examples, the method 800 further comprises providing, by an output device of the mobile computing device, user-selectable options for responding to the security inconsistency. The user-selectable options may include an option to reset the operating condition to the secured state. For example, if the security inconsistency relates to a peripheral device, the user-selectable option may include an option to set the current state of the peripheral device to the secured state.

The method 800 may further include providing a notification of the security inconsistency to a central security administrator, such as an IT administrator, of the mobile computing device. The central security administrator may take one or more possible actions, such as protecting other mobile devices, locking down the mobile device, uninstalling the malware, changing the state of the peripheral device to one of the authorized states, or changing the security policy. In one example, the method 800 further includes receiving, at the mobile computing device, an indication to set the current state of the peripheral device to the secured state. The method 800 may further include switching, responsive to receiving the indication, the current state of the peripheral device to the secured state.

In some examples, the method 800 further includes comparing a pattern of past use associated with the first peripheral device to a current use associated with the first peripheral device. By comparing a pattern of past use of the first peripheral device, the mobile computing device may be able to discern whether a change in state of the first peripheral device is due to user activity or due to malware. In some examples of the method 800, detecting the security inconsistency may include determining that the current use associated with the first peripheral device does not match the pattern of past use associated with the first peripheral device. Additionally, the method 800 may determine the pattern of past use based at least in part on correspondence between active applications and states of the first peripheral device. Some examples of the method 800 further include determining a pattern of use for subsequent monitoring of the first peripheral device based on user input of the user-selectable option.

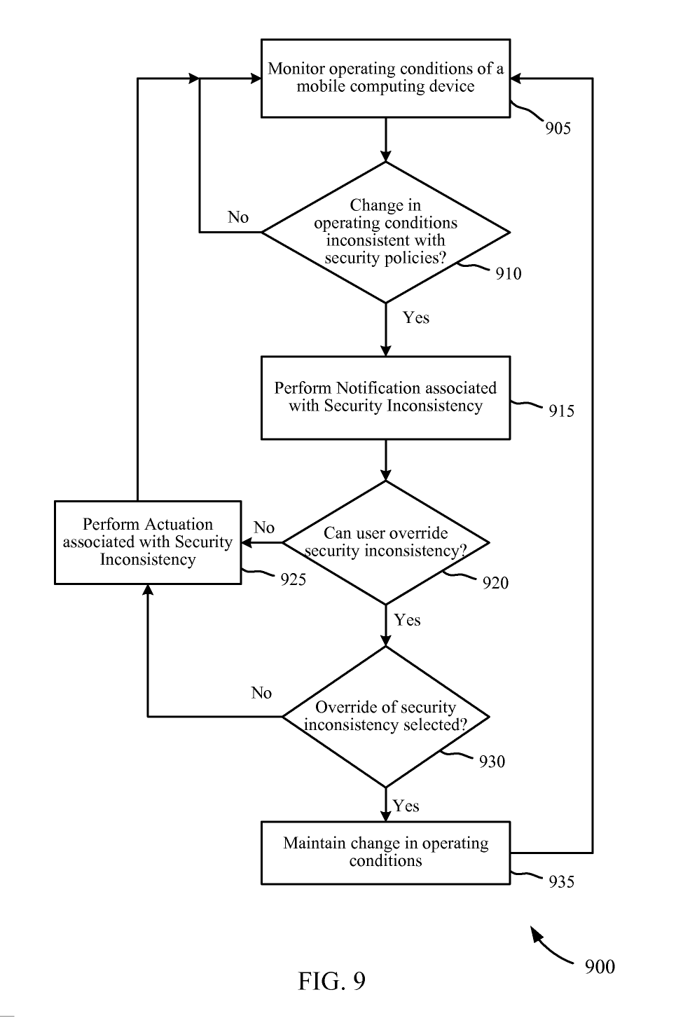

FIG. 9 is a flowchart of an example method for taking corrective action in response to a security inconsistency, in accordance with various aspects of the present disclosure. For clarity, the method 900 may apply to aspects of one or more of the mobile devices 115 described with reference to any of FIG. 1, 2, 3, 4 or 7, aspects of the HW/SW stack 500 of FIG. 5, or aspects of the apparatus 605 of FIG. 6. For example, the method 900 may be performed by security client 205 as described above with regard to FIGS. 2, 3, 5A, 6 or 7. In some examples, a mobile device 115 or apparatus may execute one or more sets of codes to control the functional elements of the mobile device 115 or apparatus to perform the functions described below.

At block 905, the method 900 includes monitoring operating conditions of a mobile computing device. For example, the operating conditions may include states of device peripherals, application installations, and/or network communications. The operating conditions may be monitored with respect to security policies for the mobile device. The operating conditions may be monitored at multiple software levels (e.g., access control level, service level, etc.). The security policies may include, for example, security policies associated with hardware peripheral use, an application whitelist, an application blacklist, and/or firewall capabilities.

At block 910, the method 900 includes determining if a change in operating conditions is inconsistent with the security policies. For example, the security client may determine that installation of an application, various network communications, or an adverse hardware change is inconsistent with the security policies. If not inconsistent operating conditions are found at block 910, the method 900 may continue to monitor the operation conditions at block 905.

If one or more operating conditions are determined to be inconsistent with the security policies at block 910, the method 900 may perform a notification associated with the security inconsistency at block 915. For example, the security client may (e.g., via the mobile OS, etc.) output a visual, audible, and/or physical notification of the security inconsistency. The notification may inform the user of a potential security breach. Additionally or alternatively, the notification may present one or more user-selectable actions to be performed in response to the change in operating conditions, which may include accepting the change in operating conditions, reverting to the secured state, notifying a system administrator, and the like.

The method 900 may proceed to block 920, where the method 900 may determine if the user can override the security inconsistency. For example, the security policies may indicate that certain actions should trigger a notification that requires acceptance and/or authorization of the change in operating conditions by the user. In other instances, the security policies may indicate that the user is not authorized to override the change in operating conditions detected at block 910.

Where the user is not authorized to override the security inconsistency, the method 900 may perform one or more actuations associated with the security inconsistency at block 925. For example, the security client may (e.g., via the mobile OS, etc.) perform actuations including uninstalling an application, setting the operating condition to the secured state (e.g., changing the state of a peripheral device to the secured state, etc.), blocking a data transfer, erasing data stored by the mobile device, locking the mobile device, rebooting the mobile device, blocking access to data containers, blocking an IPC connection, blocking hardware signals (e.g., interrupts, etc.), blocking data transfers to and/or from memory, blocking input/output from peripherals, blocking software interrupts, blocking system calls, blocking traps, erasing data containers, locking data containers, and the like.

Where the user is authorized to override the security inconsistency, the method 900 may determine at block 930 if the user has selected an option to override the security inconsistency. Where the user has not elected to override the security inconsistency at block 930, the method 900 may proceed to perform the one or more actuations at block 925. Where the user has elected to override the security inconsistency at block 930, the method may proceed to block 935, where the change in operating conditions is maintained (e.g., no actuation is performed, etc.). In some embodiments, the security client may update the security policies based on the user electing to override the security inconsistency at block 930. For example, if the change in operating conditions corresponds to a user-configurable security setting (e.g., user-configurable whitelist, etc.), the user-configurable security setting may be updated based on the election to override the security inconsistency by the user.

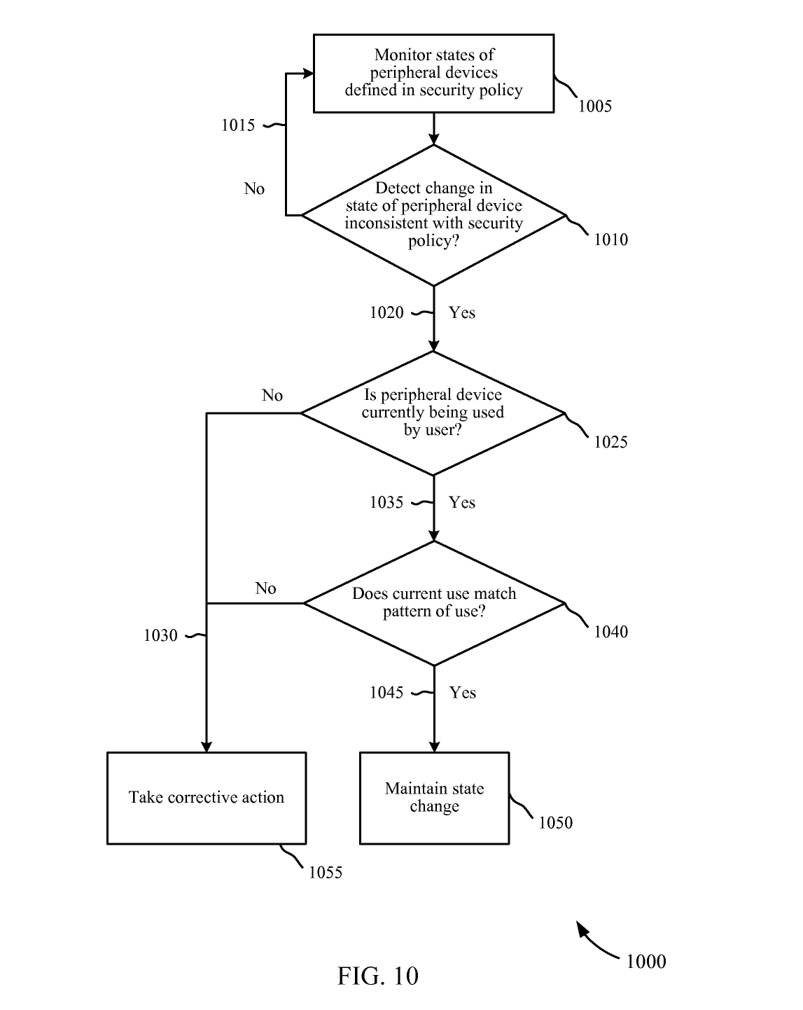

FIG. 10 is a flowchart of an example method 1000 for detecting a state change for a peripheral device of a mobile computing device, in accordance with various aspects of the present disclosure. For clarity, the method 1000 may apply to aspects of one or more of the mobile devices 115 described with reference to any of FIGS. 1-4 and/or 7, aspects of the HW/SW stack 500 of FIG. 5A, or aspects of the apparatus 605 of FIG. 6. For example, the method 1000 may be performed by security client 205 as described above with regard to FIGS. 2, 3, 5A, 6 or 7. In some examples, a mobile device or apparatus may execute one or more sets of codes to control the functional elements of the mobile device or apparatus to perform the functions described below.

At block 1005, the method 1000 includes monitoring states of one or more peripheral devices that are defined and/or included in a security policy for the mobile device 115. That is, the security client 205 may monitor peripheral devices 405 of mobile device 115 for any adverse hardware change. An adverse hardware change could be any change to a peripheral device 505 that deviates from the security policies 210. The monitoring may include monitoring operational states of peripheral devices of the mobile device 115 at multiple software levels (e.g., access control level, service level, etc.).

At block 1010, the method 1000 determines whether a change in a state of one or more peripheral devices 505 is inconsistent with the security policies 210. If not, the method 1000 follows path 1015 and continues to monitor the states of the peripheral devices 505.

If a change has been detected in a state of one or more peripheral devices 505, the method 1000 follows path 1020 and next queries whether the peripheral device is currently being used by a user of the mobile device 115 at block 1025. If the peripheral device is currently being used by the user, the method 1000 follows path 1035 and next determines whether the current use matches a pattern of use at block 1040. The method 1000 determines whether a current use conforms to a pattern of authorized use to determine if the user has initiated the change in peripheral device state, or if the change in peripheral device state is more likely the result of malicious code or communications. If the method 1000 determines that the current use matches an authorized pattern of past use, the method proceeds along path 1045 and maintains the state change for the peripheral device at block 1050. The method 1000 may not issue a notification indicating a detected security inconsistency because the method 1000 has determined it is likely, above a threshold level, that the user has intentionally caused the security inconsistency. In other examples, the method 1000 outputs a notification regardless of any determined or hypothesized cause of the security inconsistency.

If the peripheral device is not currently being used by a user or the current use of the peripheral device does not match an authorized pattern of past use, the method 1000 follows path 1030 and takes a corrective action for the security inconsistency at block 1055. The corrective action may be, for example, issuing a notification of the security inconsistency, sending a message to an IT administrator, reformatting the mobile computing device, and/or changing the state of the peripheral device to a state defined as authorized in the security policies. In other examples, other corrective actions may be taken.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for security in a mobile computing device, comprising:
monitoring one or more operating conditions of the mobile computing device according to one or more security policies;
detecting a security inconsistency between a current state of the one or more operating conditions and a secured state of the one or more operating conditions, wherein the secured state is defined by the one or more security policies; and
issuing, by an output device of the mobile computing device, a notification based at least in part on the detection of the security inconsistency.

2. The method of claim 1, further comprising:
performing, automatically upon detection of the security inconsistency, an action at the mobile computing device to mitigate the security inconsistency.

3. The method of claim 2, wherein the action comprises one or more of uninstalling an application, setting the one or more operating conditions to the secured state, blocking a data transfer, erasing data stored by the mobile computing device, locking the mobile computing device, rebooting the mobile computing device, blocking access to data of at least one data container, blocking at least one inter-process communication connection, blocking at least one hardware signal, blocking at least one memory data transfer, blocking data transfer from at least one peripheral, blocking at least one software interrupt, blocking at least one system call, blocking at least one trap, erasing data of at least one data container, locking at least one data container, or combinations thereof

4. The method of claim 2, wherein the one or more security policies comprises associations between a set of security inconsistencies and a respective set of actions.

5. The method of claim 1, wherein the monitoring the one or more operating conditions of the mobile computing device comprises monitoring the one or more operating conditions at a plurality of software levels of the mobile computing device.

6. The method of claim 1, wherein the one or more security policies are maintained in an application sandbox associated with a security client application of the mobile computing device.

7. The method of claim 1, further comprising:
configuring the mobile computing device according to a mobile device configuration comprising the one or more security policies, wherein the one or more operating conditions are set to match the secured state.

8. The method of claim 1, further comprising:
determining that the security inconsistency is an unauthorized security inconsistency.

9. The method of claim 8, wherein determining that the security inconsistency is an unauthorized security inconsistency further comprises:
comparing a current use of the mobile computing device to a pattern of past use of the mobile computing device; and
determining that the current use of the mobile computing device does not match the pattern of past use of the mobile computing device.

10. The method of claim 9, further comprising:
determining the pattern of use of the mobile computing device based on user input to one or more applications of the mobile computing device.

11. The method of claim 1, further comprising:
providing a second notification of the security inconsistency to a central security administrator of the mobile computing device.

12. The method of claim 1, further comprising:
providing, by the output device of the mobile computing device, a user-selectable option to set the current state of the one or more operating conditions to the secured state.

13. The method of claim 1, wherein the one or more operating conditions comprise states for one or more peripheral devices, and wherein the one or more peripheral devices comprise at least one of a camera, a microphone, a speaker, a Bluetooth network device, a wireless network device, a display, a memory card, an internal memory, a gyroscope, an accelerometer, a global positioning system (GPS) receiver, or a combination thereof.

14. The method of claim 13, wherein the one or more peripheral devices comprises peripheral devices internal to the mobile computing device.

15. The method of claim 13, wherein the one or more peripheral devices comprises the camera, and wherein the security inconsistency comprises the current state of the camera being enabled and the secured state of the camera being disabled.

16. The method of claim 1, wherein issuing the notification comprises one or more of outputting an auditory alert, outputting a visual alert, vibrating the mobile computing device, or a combination thereof

17. An apparatus for security in a mobile computing device, comprising:
a processor;
memory in electronic communication with the processor; and
instructions stored in the memory, the instructions being executable by the processor to:
monitor one or more operating conditions of the mobile computing device according to one or more security policies;
detect a security inconsistency between a current state of the one or more operating conditions and a secured state of the one or more operating conditions, wherein the secured state is defined by the one or more security policies; and
issue, by an output device of the mobile computing device, a notification based at least in part on the detection of the security inconsistency.

18. The apparatus of claim 17, wherein the instructions are further executable by the processor to perform, automatically upon detection of the security inconsistency, an action at the mobile computing device to mitigate the security inconsistency.

19. The apparatus of claim 18, wherein the action comprises one or more of uninstalling an application, setting the one or more operating conditions to the secured state, blocking a data transfer, erasing data stored by the mobile computing device, locking the mobile computing device, rebooting the mobile computing device, blocking access to data of at least one data container, blocking at least one inter-process communication connection, blocking at least one hardware signal, blocking at least one memory data transfer, blocking data transfer from at least one peripheral, blocking at least one software interrupt, blocking at least one system call, blocking at least one trap, erasing data of at least one data container, locking at least one data container, or combinations thereof.

20. The apparatus of claim 18, wherein the one or more security policies comprises associations between a set of security inconsistencies and a respective set of actions.

21. The apparatus of claim 17, wherein the instructions are further executable by the processor to monitor the one or more operating conditions at a plurality of software levels of the mobile computing device.

22. The apparatus of claim 17, wherein the one or more security policies are maintained in an application sandbox associated with a security client application of the mobile computing device.

23. The apparatus of claim 17, wherein the instructions are further executable by the processor to configure the mobile computing device according to a mobile device configuration comprising the one or more security policies, wherein the one or more operating conditions are set to match the secured state.

24. The apparatus of claim 17, wherein the instructions are further executable by the processor to determine that the security inconsistency is an unauthorized security inconsistency.

25. The apparatus of claim 24, wherein the instructions are further executable by the processor to:
compare a current use of the mobile computing device to a pattern of past use of the mobile computing device; and
determine that the current use of the mobile computing device does not match the pattern of past use of the mobile computing device.

26. The apparatus of claim 25, wherein the instructions are further executable by the processor to determine the pattern of use of the mobile computing device based on user input to one or more applications of the mobile computing device.

27. The apparatus of claim 17, wherein the instructions are further executable by the processor to provide a second notification of the security inconsistency to a central security administrator of the mobile computing device.

28. The apparatus of claim 17, wherein the instructions are further executable by the processor to provide, by the output device of the mobile computing device, a user-selectable option to set the current state of the one or more operating conditions to the secured state.

29. The apparatus of claim 17, wherein the one or more operating conditions comprise states for one or more peripheral devices, and wherein the one or more peripheral devices comprise at least one of a camera, a microphone, a speaker, a Bluetooth network device, a wireless network device, a display, a memory card, an internal memory, a gyroscope, an accelerometer, a global positioning system (GPS) receiver, or a combination thereof.

30. The apparatus of claim 29, wherein the one or more peripheral devices comprises peripheral devices internal to the mobile computing device.

31. The apparatus of claim 29, wherein the one or more peripheral devices comprises the camera, and wherein the security inconsistency comprises the current state of the camera being enabled and the secured state of the camera being disabled.

32. The apparatus of claim 17, wherein issuing the notification comprises one or more of outputting an auditory alert, outputting a visual alert, vibrating the mobile computing device, or a combination thereof.

33. A non-transitory computer-readable medium storing code for notification in a mobile computing device, the code comprising instructions executable by a processor for:
monitoring one or more operating conditions of the mobile computing device according to one or more security policies;
detecting a security inconsistency between a current state of the one or more operating conditions and a secured state of the one or more operating conditions, wherein the secured state is defined by the one or more security policies; and
issuing, by an output device of the mobile computing device, a notification based at least in part on the detection of the security inconsistency.
